(19) United States
(12) Patent Application Publication
(10) Pub. No.: US 2024/0162851 A1
(43) Pub. Date: May 16, 2024

(54) Sun-Tracking Solar Power Generating Apparatus and the Solar Panel Thereof

(71) Applicant: Season Energy Technology Co., Ltd., Tainan City (TW)

(72) Inventor: Lin-Hung Chang, Tainan City (TW)

(21) Appl. No.: 17/986,073

(22) Filed: Nov. 14, 2022

(51) Int. Cl. H02S 20/32; H02S 30/10; H02S 40/22; H02S 40/42

(52) U.S. Cl. CPC H02S 20/32; H02S 30/10; H02S 40/22; H02S 40/425

(57) ABSTRACT

A sun-tracking solar power generating apparatus includes an upright post (10), a frame (20) located above the upright post, a pivot device (30) pivotally mounted between a top of the upright post and a bottom of the frame, an inclination adjusting device (40) mounted between the upright post and the frame, multiple solar panels (50) mounted on the frame, and a temperature adjustment device (60) mounted on the bottom of the frame. Each of the solar panels includes a self-cleaning reflective layer (53) disposed at an outer face thereof. The self-cleaning reflective layer is made of Teflon material.

### BACKGROUND OF THE INVENTION

### 1. Field of the Invention

The present invention relates to a solar tracking system and, more particularly, to a sun-tracking solar power generating apparatus and the solar panel thereof.

### 2. Description of the Related Art

A solar panel is used to collect the sunlight, and then convert the solar energy into an electric power by a photoelectric conversion. Then, the electric power is delivered into and stored by a battery for use in the future. The sunlight with a wavelength ranging between 300 nm and 700 nm can be effectively converted into an electric power. However, the sunlight (such as the infrared light IR) with a wavelength more than 700 nm cannot be effectively converted into an electric power, and the heat will accumulate in the solar panel so that the working temperature of the solar panel is increased successively, thereby decreasing the power generating efficiency. In addition, the ambient or environmental temperature is also one of the factors that decrease the power generation efficiency. If the ambient temperature is higher than 25 degrees C., the power generation efficiency will gradually decrease. Moreover, most of the conventional solar panels at present are of the scaffold type, and their shading area is too large. When used on an agricultural land, the solar panel is easy to shade the crops, thereby causing insufficient sunlight for crops.

### BRIEF SUMMARY OF THE INVENTION

The primary objective of the present invention is to provide a sun-tracking solar power generating apparatus that enhances the power generating efficiency, reduces the covering area, saves the cost of maintenance, and increases the lifetime.

In accordance with the present invention, there is provided a sun-tracking solar power generating apparatus comprising an upright post, a frame located above the upright post, a pivot device pivotally mounted between a top of the upright post and a bottom of the frame, an inclination adjusting device mounted between the upright post and the frame, multiple solar panels mounted on the frame, and a temperature adjustment device mounted on the bottom of the frame. The pivot device is operated when the frame is subjected to an external force so that the frame is pivoted and inclined relative to the upright post. The inclination adjusting device drives the frame to pivot relative to the upright post to adjust an inclined angle of the frame. Each of the solar panels includes a self-cleaning reflective layer disposed at an outer face thereof. The self-cleaning reflective layer is made of Teflon material. The temperature adjustment device is used to regulate an environmental temperature of the solar panels.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a sun-tracking solar power generating apparatus in accordance with the preferred embodiment of the present invention.

FIG. 2 is a schematic operational view of the sun-tracking solar power generating apparatus as shown in FIG. 1.

FIG. 3 is a locally enlarged schematic operational view of the sun-tracking solar power generating apparatus as shown in FIG. 1.

FIG. 4 is a schematic view of the sun-tracking solar power generating apparatus in accordance with the preferred embodiment of the present invention.

### DETAILED DESCRIPTION OF THE INVENTION

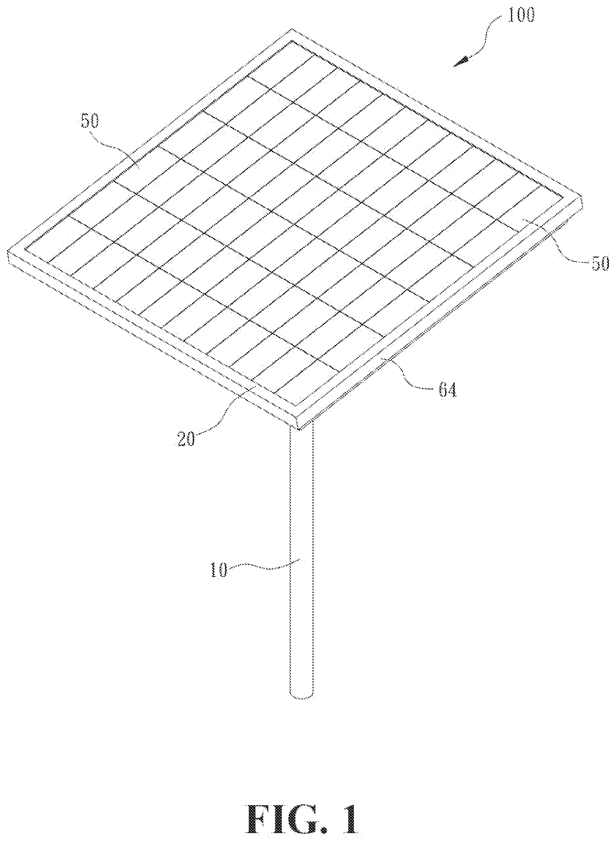

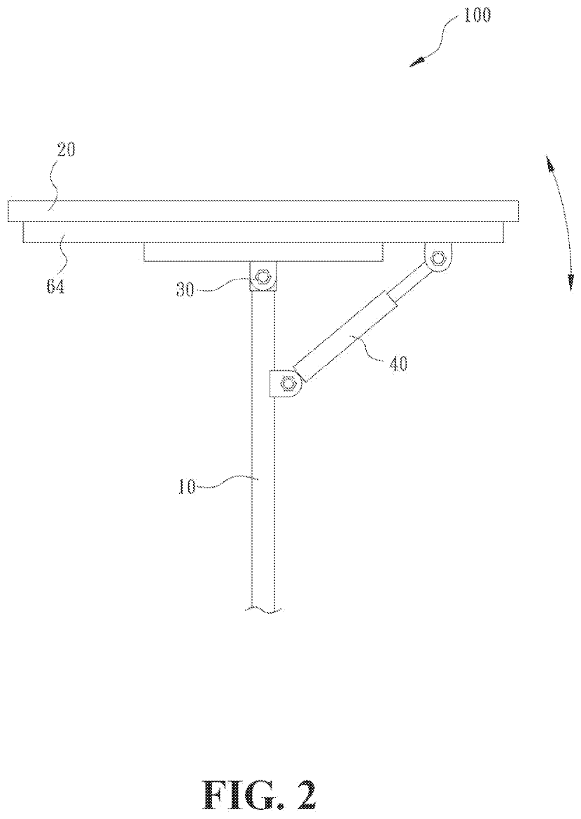

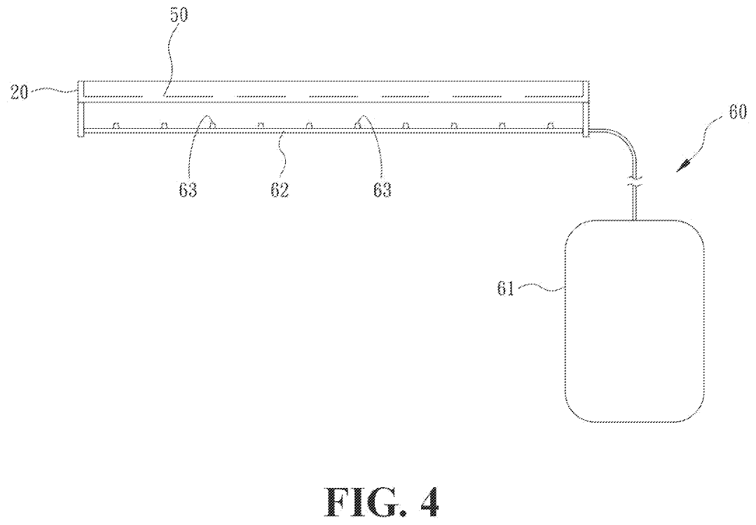

Referring to FIGS. 1-4, a sun-tracking solar power generating apparatus 100 in accordance with the preferred embodiment of the present invention comprises an upright post 10, a frame 20 located above the upright post 10, a pivot device 30 pivotally mounted between a top of the upright post 10 and a bottom of the frame 20, an inclination adjusting device 40 mounted between the upright post 10 and the frame 20, multiple solar panels 50 mounted on the frame 20, and a temperature adjustment device 60 mounted on the bottom of the frame 20.

The upright post 10 is placed on the ground steadily. The pivot device 30 is operated when the frame 20 is subjected to an external force so that the frame 20 is pivoted and inclined relative to the upright post 10. The inclination adjusting device 40 drives the frame 20 to pivot relative to the upright post 10 so as to adjust an inclined angle of the frame 20. The frame 20 is positioned by the inclination adjusting device 40. Each of the solar panels 50 includes a self-cleaning reflective layer 53 disposed at an outer face thereof. The self-cleaning reflective layer 53 is made of Teflon material. The temperature adjustment device 60 is used to regulate an environmental temperature of the solar panels 50.

In the preferred embodiment of the present invention, the inclination adjusting device 40 includes at least one pneumatic cylinder or at least one hydraulic cylinder.

In the preferred embodiment of the present invention, each of the solar panels 50 further includes a P-type semiconductor 51 and an N-type semiconductor 52 that are combined together. An electric current is produced by the potential difference between the P-type semiconductor 51 and the N-type semiconductor 52, and the manner for producing the current is traditional and will not be further described in detail. The self-cleaning reflective layer 53 is formed on an outer face of the N-type semiconductor 52 by coating. The self-cleaning reflective layer 53 has an outer surface 531 and an inner surface 532 opposite to the outer surface 531. The inner surface 532 of the self-cleaning reflective layer 53 is adhered to the outer face of the N-type semiconductor 52. The outer surface 531 of the self-cleaning reflective layer 53 is an uneven surface with multiple concave sections and multiple convex sections. The outer surface 531 of the self-cleaning reflective layer 53 is directed outward and upward.

In the preferred embodiment of the present invention, the temperature adjustment device 60 includes a water storage container 61, at least one water pipe 62, multiple spraying nozzles 63, and a cover 64. The water storage container 61 is used to store water therein. The at least one water pipe 62 is secured to the bottom of the frame 20 and located under the solar panels 50. The at least one water pipe 62 is connected to the water storage container 61. The spraying nozzles 63 are mounted on the at least one water pipe 62 and directed toward the solar panels 50. The cover 64 is mounted on the frame 20 and surrounds a periphery of the bottom of the frame 20 to cover the at least one water pipe 62 and the spraying nozzles 63.

In the preferred embodiment of the present invention, each of the solar panels 50 includes a P-type semiconductor 51, an N-type semiconductor 52 combined with P-type semiconductor 51, and a self-cleaning reflective layer 53 formed on an outer face of the N-type semiconductor 52 by coating. The self-cleaning reflective layer 53 is made of Teflon material. The self-cleaning reflective layer 53 has an outer surface 531 and an inner surface 532 opposite to the outer surface 531. The inner surface 532 of the self-cleaning reflective layer 53 is adhered to the outer face of the N-type semiconductor 52. The outer surface 531 of the self-cleaning reflective layer 53 is an uneven surface with multiple concave sections and multiple convex sections. The outer surface 531 of the self-cleaning reflective layer 53 is directed outward and upward.

In use, when the temperature adjustment device 60 is operated, water in the water storage container 61 is delivered through the at least one water pipe 62 to the spraying nozzles 63 which inject and spray the water toward the solar panels 50 to reduce the environmental temperature around the solar panels 50, thereby preventing the solar panels 50 from failing or being inoperative due to an excessive temperature, and thereby enhancing the power generating efficiency of the solar panels 50.

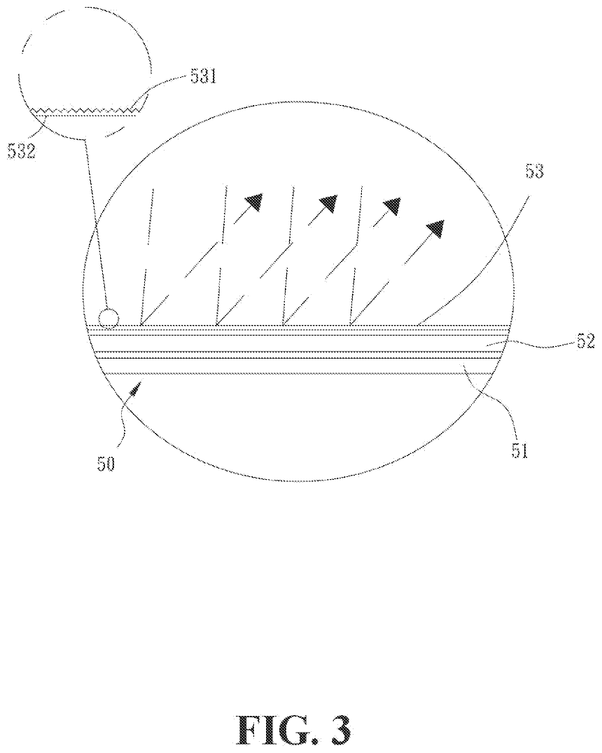

In addition, the outer surface 531 of the self-cleaning reflective layer 53 is closest to the sun. When the solar rays are irradiated to the outer surface 531 of the self-cleaning reflective layer 53, the light (or infrared light) with a wavelength more than 700 nm is reflected by concave and convex sections of the uneven surface as shown in FIG. 3, and only the light with a wavelength less than 700 nm is allowed to enter the self-cleaning reflective layer 53 to execute the photoelectric conversion, so that the solar panels 50 will not accumulate excess heat, thereby preventing the working temperature from rising too high, reducing the heat loss, and enhancing the power generating efficiency.

Further, the self-cleaning reflective layer 53 at the outermost side of each of the solar panels 50 is made of Teflon material having an anti-stick feature, and foreign objects, such as dust, leaves or bird excrements, are not stuck to the self-cleaning reflective layer 53 easily, so that the self-cleaning reflective layer 53 is cleared easily, thereby reducing the cost of maintenance and enhancing the lifetime.

Further, the upright post 10 occupies a small space to reduce the covering area and has a height which is changed according to that of the crops on the ground to protect the growth condition of the crops so that the crops have full amount of sunshine.

Further, the frame 20 is pivoted and inclined relative to the upright post 10 by control of the inclination adjusting device 40 so that the solar panels 50 are kept perpendicular to the sun light constantly to obtain the most amount of light. Besides, the solar panels 50 are disposed horizontally when the wind is too strong, thereby reducing the loss.

In another preferred embodiment of the present invention, multiple sun-tracking solar power generating apparatuses are arranged in a matrix, wherein the inclined angles of the sun-tracking solar power generating apparatuses are designed individually to prevent from sheltering each other, to stabilize the power generation, and to enhance the land usage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1: A sun-tracking solar power generating apparatus comprising:
an upright post (10);
a frame (20) located above the upright post;
a pivot device (30) pivotally mounted between a top of the upright post and a bottom of the frame;
an inclination adjusting device (40) mounted between the upright post and the frame;
multiple solar panels (50) mounted on the frame; and
a temperature adjustment device (60) mounted on the bottom of the frame;
wherein:
the pivot device is operated when the frame is subjected to an external force so that the frame is pivoted and inclined relative to the upright post;
the inclination adjusting device drives the frame to pivot relative to the upright post to adjust an inclined angle of the frame;
each of the solar panels includes a self-cleaning reflective layer (53) disposed at an outer face thereof;
the temperature adjustment device is used to regulate an environmental temperature of the solar panels;
each of the solar panels further includes a P-type semiconductor (51) and an N-type semiconductor (52) that are combined together;
the self-cleaning reflective layer is formed on an outer face of the N-type semiconductor;
the self-cleaning reflective layer has an outer surface (531) and an inner surface (532) opposite to the outer surface;
the inner surface of the self-cleaning reflective layer is adhered to the outer face of the N-type semiconductor;
the outer surface of the self-cleaning reflective layer is an uneven surface with multiple concave sections and multiple convex sections; and
the outer surface of the self-cleaning reflective layer is directed outward and upward.

2: The sun-tracking solar power generating apparatus as claimed in claim 1, wherein the inclination adjusting device includes at least one pneumatic cylinder or at least one hydraulic cylinder.

3. (canceled)

4: The sun-tracking solar power generating apparatus as claimed in claim 1, wherein:
the temperature adjustment device includes a water storage container (61), at least one water pipe (62), multiple spraying nozzles (63), and a cover (64);
the at least one water pipe is secured to the bottom of the frame and located under the solar panels;
the at least one water pipe is connected to the water storage container;
the spraying nozzles are mounted on the at least one water pipe and directed toward the solar panels; and
the cover is mounted on the frame and surrounds a periphery of the bottom of the frame.

5. (canceled)

6: The sun-tracking solar power generating apparatus as claimed in claim 1, wherein the self-cleaning reflective layer is directly coated on the outer face of the N-type semiconductor.

7: The sun-tracking solar power generating apparatus as claimed in claim 1, wherein the inner surface of the self-cleaning reflective layer is in direct contact with the outer face of the N-type semiconductor.

8: The sun-tracking solar power generating apparatus as claimed in claim 4, wherein the cover is disposed between the frame and the pivot device, and the pivot device is disposed between the cover and the upright post.

9: The sun-tracking solar power generating apparatus as claimed in claim 8, wherein the inclination adjusting device is mounted between the upright post and the cover.

10: The sun-tracking solar power generating apparatus as claimed in claim 4, wherein the at least one water pipe is spaced from the solar panels.

11: The sun-tracking solar power generating apparatus as claimed in claim 4, wherein the spraying nozzles are spaced from the solar panels.

12: The sun-tracking solar power generating apparatus as claimed in claim 1, wherein the inclination adjusting device is inclined relative to the upright post.

13: The sun-tracking solar power generating apparatus as claimed in claim 1, wherein the inclination adjusting device is inclined relative to the frame.
